(19) United States
(12) Patent Application Publication
(10) Pub. No.: US 2025/0310203 A1
(43) Pub. Date: Oct. 2, 2025

(54) ONTOLOGY SYSTEMS FOR MONITORING DATA HANDLING FACILITIES OF A COMMUNICATION SYSTEM

(71) Applicant: T-Mobile Innovations LLC, Overland Park, KS (US)

(72) Inventors: Manjith BAHULEYAN, Bothell, WA (US); John COSTER, Seattle, WA (US); Vikas RANJAN, Bellevue, WA (US); Sean Michael Clarke SEEMANN, Seattle, WA (US)

(21) Appl. No.: 18/617,598

(22) Filed: Mar. 26, 2024

(51) Int. Cl. H04L 41/12; G06F 1/28; H04L 41/0833; H04L 41/0893

(52) U.S. Cl. CPC H04L 41/12; G06F 1/28; H04L 41/0833; H04L 41/0893

(57) ABSTRACT

A method for managing an ontology of a data handling facility of a communication system. The method includes discovering connections between some of a plurality of electrically powered components of the data handling facility based on time-series data obtained from a plurality of electrical power monitors, and forming a physical ontology layer of the data handling facility and a logical ontology layer of the data handling facility. In addition, the method includes receiving a query from a user concerning a hypothetical modification to the operation of the data handling facility, and forecasting change in the operation of the data handling facility based on the query received from the user.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Communication systems, including systems incorporating telecommunications and data networks, rely on robust and scalable data handling infrastructure to support the increasing demand for high-speed data transfer and low-latency communication across the communication system. Particularly, data handling facilities, such as data centers (e.g., mini-data centers, mobile switching offices), form the backbone of communication systems by providing centralized storage, processing, and management of data communicated thereacross. The demand for agile, efficient, and scalable data handling facilities has increased with the growing volume and complexity of networked applications and services.

### SUMMARY

In an embodiment, a method for managing an ontology of a data handling facility of a communication system is disclosed. The method includes discovering by an auto-discovery tool physical connections between some of a plurality of electrically powered components of the data handling facility based on time-series data obtained from a plurality of electrical power monitors connected between the electrically powered components of the data handling facility, and forming by an ontology engine a physical ontology layer of the data handling facility that includes the physical connections between different physical nodes representing physical components of the data handling facility discovered by the auto-discovery tool. In addition, the method includes forming by the ontology engine a logical ontology layer of the data handling facility including logical connections between logical nodes representing components of the data handling facility, wherein the logical connections are separate from the physical connections of the physical ontology layer and express logical relationships between the electrically powered components connected by the logical connections. Further, the method includes receiving by a query tool of the ontology engine a query from a user concerning a hypothetical modification to the operation of the data handling facility, and forecasting by the ontology engine a change in the operation of one or more of the plurality of electrically powered components of the data handling facility based on the query received by the query tool from the user.

In an embodiment, an additional method for managing an ontology of a data handling facility of a communication system is disclosed. The method includes discovering by an auto-discovery tool physical connections between some of a plurality of electrically powered components of the data handling facility based on time-series data obtained from a plurality of electrical power monitors connected between the electrically powered components of the data handling facility, and forming by an ontology engine a physical ontology layer of the data handling facility that includes the physical connections between different physical nodes representing physical components of the data handling facility discovered by the auto-discovery tool. In addition, the method includes forming by the ontology engine a logical ontology layer of the data handling facility including logical connections between logical nodes representing components of the data handling facility, wherein the logical connections are separate from the physical connections of the physical ontology layer and express logical relationships between the electrically powered components connected by the logical connections, and interleaving by the ontology engine the logical ontology layer with the physical ontology layer to form a single data structure in the form of an ontology of the data handling facility.

In an embodiment, an additional method for managing an ontology of a data handling facility of a communication system is disclosed. The method includes discovering by an auto-discovery tool physical connections between some of a plurality of electrically powered components of the data handling facility based on time-series data obtained from a plurality of electrical power monitors connected between the electrically powered components of the data handling facility, forming by an ontology engine a physical ontology layer of the data handling facility that includes the physical connections between different physical nodes representing physical components of the data handling facility discovered by the auto-discovery tool. In addition, the method includes classifying by the ontology engine in accordance with a predefined taxonomy at least some of the electrically powered components of the data handling facility based on the time-series data obtained from the plurality of electrical power monitors, and forming by the ontology engine a logical ontology layer of the data handling facility including logical connections between logical nodes representing components of the data handling facility, wherein the logical connections are separate from the physical connections of the physical ontology layer and express logical relationships between the electrically powered components connected by the logical connections.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system according to an embodiment of the disclosure.

FIG. 2 is a schematic diagram of a data handling facility according to an embodiment of the disclosure.

FIG. 3 is a diagram of a power system of a data handling facility according to an embodiment of the disclosure;

FIG. 4 is a facility ontology of a data handling facility according to an embodiment of the disclosure.

FIG. 5 is flow chart of a method for managing an ontology of a data handling facility of a communication system according to an embodiment of the disclosure.

FIG. 6 is flow chart of another method for managing an ontology of a data handling facility of a communication system according to an embodiment of the disclosure.

FIG. 7 is flow chart of another method for managing an ontology of a data handling facility of a communication system according to an embodiment of the disclosure.

FIG. 8A is a block diagram of another communication system according to an embodiment of the disclosure.

FIG. 8B is a block diagram of a core network of the communication system of FIG. 8A according to an embodiment of the disclosure.

FIG. 9 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

It is understood that modern communication networks transport communication content, including voice communication, in the form of digitally encoded data. As described above, data handling facilities of communication systems form the backbone of the communication system such that data (e.g., in the form of network traffic) may be communicated across the communication system as desired by a plurality of end users of the communication system. Particularly, data handling facilities house the telecommunication hardware comprising computer systems in the form of servers, network switches, routers, datastores, and other equipment used to route data across the communication system or which otherwise facilitates the management of the communication system. As an example, telecommunication hardware may comprise modular components, including server racks, can be easily added or removed to adjust to changing requirements. In addition, data handling facilities may utilize high-density computing equipment, such as blade servers and optimized server designs, to maximize processing power within a given physical footprint. Further, efficient space utilization is achieved through techniques like virtualization and containerization.

Data handling facilities furnish the telecommunication hardware with different resources so that the hardware may operate as intended by an operator or network provider of the communication system. For example, data handling facilities include physical support structures (e.g., physical infrastructure) that provides the telecommunication hardware with the physical space required for properly housing said telecommunication hardware. In addition, data handling facilities include power systems for providing the telecommunication hardware contained in the data handling facility with the electrical power required by the telecommunication hardware for its normal operation. Further, data handling facilities include cooling systems for maintaining the telecommunication hardware within its respective normal operating temperature ranges in spite of the often-substantial heat generated by the telecommunication hardware during normal operation. Data handling facilities may include auxiliary systems as well for providing physical security for the telecommunication hardware, preventing or suppressing fires within the data handling facility, as well as for other purposes.

In some embodiments, data handling facilities may comprise buildings (e.g., an office building or other commercial building) having a defined and fixed amount of furnishable physical space (e.g., defined in terms of square footage) in which telecommunication hardware may be housed and protected from the ambient external environment. To state in other words, in some instances data handling facilities have a fixed physical space capacity. At any given time, only a portion of the physical space capacity of the data handling facility may be used to house telecommunication hardware or other equipment, leaving a variable quantity of unused physical space that may be challenging to monitor over time.

The available space, power, and cooling capacities of data handling facilities may be documented or estimated in different ways. For example, the space, power, cooling capacities of a given data handling facility may be captured in construction or engineering drawings created during initial construction of the data handling facility. However, engineering and similar drawings are not always a reliable indicator of the current capacities of the data handling facility making it difficult to determine or monitor the current space, power, and/or cooling capacities of data handling facilities from available resources like engineering drawings.

For instance, engineering drawings may contain errors (e.g., pertaining to parameters of infrastructural components, electrically powered components, telecommunication hardware, and the like) such that they do not accurately reflect the space, power, or cooling capacities of the data handling facility as originally constructed and thus do not accurately reflect the current capacities of the data handling facility. Alternatively, the engineering drawing may not contain any substantial errors but the data handling facility may have been incorrectly constructed in a manner that is not consistent with the engineering drawings. In this alternative scenario, even though the engineering drawings do not contain any substantial errors, the engineering drawings still fail to accurately reflect the space, power, and cooling capacities of the data handling facility as originally constructed along with the current space capacity of the data handling facility. In a further alternative, the configuration of the data handing facility may have changed since the date of the most current engineering drawings available such that the most current engineering drawings available fail to accurately reflect the current space capacity of the data handling facility. For example, the power system of the data handling facility may have been modified to accommodate added telecommunication hardware since the date of the most current engineering drawings available.

Although enterprises operating data handling facilities in support of an ongoing mission conducted by the enterprise (e.g., the managing of a telecommunication network, the managing of an industrial operation) may possess at some level information regarding the space, power, and cooling resources of those data handling facilities, conventionally enterprises have failed to capture and integrate said information to facilitate a more rational management of the space, power, and cooling resources of the data handling facilities. In other words, while the enterprise may possess various threads of information regarding the data handling facilities that it operates, conventionally enterprises have failed to weave together these separate threads in a manner that permits the enterprise to visualize the current state of its data handling facilities as well as what would most likely occur to those data handling facilities (and to the enterprise's ability to conduct its given mission) should particular and defined hypothetical scenarios were to take place. Instead, data must be laboriously aggregated from disconnected sources and manually analyzed in order to forecast impacts to the data handling facility (or to the larger communication system comprising the data handling facility) to changes in the operation of the data handling facility.

Accordingly, systems and methods for managing ontologies of data handling facilities of communication systems are described herein. As used herein, the term “ontology” refers to a state of a data handling facility at a given point time expressed in the form of a topological data structure that may be graphical in form but can take on other forms such as a database and the like. Embodiments of ontologies described herein may be formed automatically (or at least semi-automatically) based on time-series data obtained from a plurality of electrical power monitors connected between the electrically powered components of the data handling facility. In this manner, the power monitors may capture the flow of electrical power through the data handling facility over time, including the flow of electrical power through components of the power and cooling systems thereof along with, in some embodiments, the telecommunication hardware of the data handling facility. Particularly, in some embodiments, an auto-discovery tool may be used to discover automatically physical connections between different physical nodes representing physical components (e.g., electrically powered components) of the data handling facility.

The physical connections discovered by the auto-discovery tool may be leveraged by an ontology engine to from a physical ontology (e.g., a topology or interrogable map) of the data handling facility. In addition, the ontology engine may be used to add additional ontology layers to the physical ontology provided by the auto-discovery tool that may be interleaved together by the ontology engine to form a single, integrated data structure that may take on different forms including graphical data structures (e.g., knowledge graphs), database data structures, and the like.

In some embodiments, the ontology engine may automatically classify in accordance with a predefined taxonomy the electrically powered components of the data handling facility based on the time-series data obtained from the plurality of electrical power monitors. In this manner, the classification (e.g., an electrical transformer, an electrical switching device, an electrical rectifier, and the like) may be determined automatically by the ontology engine from the time-series data without needing to rely on engineering drawings that may be incomplete, out of date, and inaccurate.

In certain embodiments, the ontology engine may form, in addition to the physical ontology layer, a logical ontology layer of the data handling facility including logical connections between logical nodes representing components of the data handling facility. The logical connections of the logical ontology layer may be separate and distinct from the physical connections of the physical ontology layer and express logical relationships between the electrically powered components connected by the logical connections. In addition, the ontology may include multiple logical ontology layers, some relating to logical connections between physical nodes (e.g., expressing logical connections between the physical nodes) representing distinct pieces of physical equipment, and some relating to logical elements such as systems which group together a plurality of physical components.

The logical connections of the logical ontology layer may be conveniently leveraged to analyze what if scenarios pertaining to the data handling facility and a greater communication system comprising the data handling facility along with a plurality of other data handling facilities that are interconnected together to form a user-accessible network. Particularly, in some embodiments, the ontology engine includes a query tool configured to receive queries from users of the ontology engine concerning a hypothetical modification to the operation of the data handling facility. The ontology engine may forecast a change in the operation of one or more of the plurality of electrically powered components (e.g., components of a power system, a cooling system, or telecommunication hardware) of the data handling facility based on the query received by the query tool from the user.

Additionally, in an embodiment, the query tool can analyze queries having a scope that spans multiple data handling facilities. For example, the query tool may analyze and provide answers to the question “can the collective data throughput of data handling facilities X, Y, and Z be increased to handle an aggregate 10% data volume increase, given the current space constraints of facilities X, Y, and Z?” The query tool may further provide a proposed solution to the query if the general answer is “Yes.” For example, the query tool may propose shifting a first type of traffic away from facility X to facility Y, shifting some of a second type of traffic from facility Z to facility X, increasing the power distribution equipment and the air conditioning equipment at facility Z (where facility Z has some extra unused space to receive additional equipment while facility X and facility Y do NOT have extra unused space), and increase a third type of traffic to facility Z, with the ultimate result of these adaptations being an overall 10% increase of data volume across facilities X, Y, and Z.

The hypothetical modification may be deliberate (e.g., what would be the operational impacts if we add new server racks to a particular room of a selected data handling facility) or incidental (e.g., what would be the operational impact if an electrical transformer of a data handling facility were to inadvertently go offline for an extended period of time). Thus, the ontology engine may be used to analyze the robustness and excess capacity of the different data handling facilities forming a communication system. The ontology engine may also be leveraged in this way to forecast whether any shortfalls in capacity (e.g., power, cooling, space, and/or network throughput capacity) may occur following a hypothetical modification to one or more data handling facilities (e.g., using ontologies mapped to these one or more data handling facilities). The ontology engine may also be leveraged to forecast impacts to a communication system comprising a plurality of data handling facilities based on a hypothetical change to the operation of one or more of the data handling facilities.

To provide a specific example, a weather event may be forecasted to potentially impact the operation of a data handling facility such as through a potential interruption in the supply of electrical power to the data handling facility through the local electric grid. In such a scenario, a user may use the query tool to investigate potential impacts to the data handling facility following a loss of external power to the data handling facility as a result of the weather event. The ontology engine may forecast a shortfall in power capacity for one or more components of the data handling facility as a result of the impact of the weather event. In addition, the ontology engine may recommend adjusting the distribution of power to the data handling facility or within the data handling facility to ensure these one or more components receive sufficient power during the course of the weather event. In some embodiments, the ontology engine may produce and potentially provide instructions for adjusting the distribution of power in the data handling facility to address the forecasted shortfall in power capacity. Alternatively, the ontology engine may recommend transferring some of the processing load of the given data handling facility temporarily to a second data handling facility outside of the storm path, as a contingency, so that even if electrical power at the given data handling facility is decreased the data handling facility will not come up short (e.g., will still be able to support the cooling load associated with the processing load of the given data handling facility). After the storm has passed and the given data handling facility is restored to normal operations, the temporarily transferred processing load can be returned from the second data handling facility to the given data handling facility.

To provide another specific example, the ontology engine may, based on historical data, forecast a future shortfall in computing or network resources in a data handling facility. In addition, the ontology engine may determine or identify the additional computing or network resources necessary to address these forecasted shortfalls such that they do not occur. Further, in some embodiments, the ontology engine may (e.g., automatically or semi-automatically) bring these identified resources online and provide them to the data handling facility to avoid the forecasted shortfall. The ontology engine may leverage existing infrastructure to bring said resources online such as existing power distribution and network equipment.

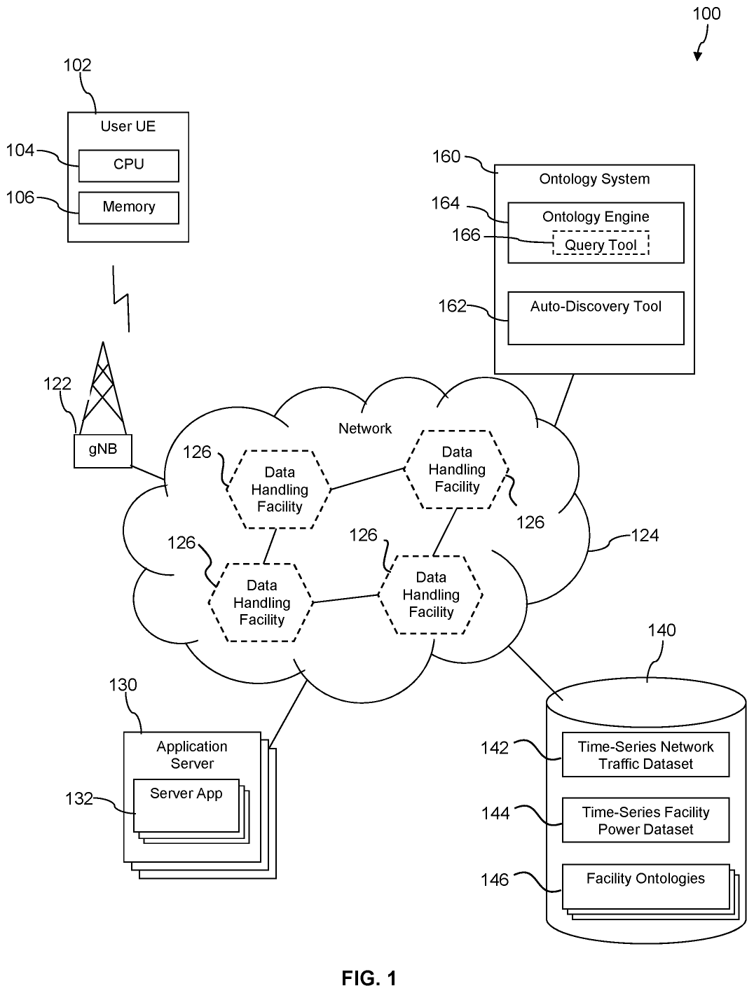

Turning to FIG. 1, a communication system 100 is described. In an embodiment, the communication system 100 generally includes a user electronic device (user equipment—UE) 102, an access node 122, a network 124, an application server 130, a datastore 140, and an ontology system 160. It may be understood that in at least some embodiments the ontology system 160 is implemented as one or more software applications executing on a computer system. UE 102 may comprise, for example, a desktop computer, a workstation, a laptop computer, a tablet computer, a smartphone, a wearable computer, an internet of things (IoT) device, and/or a notebook computer. UE 102 may be operated by a user or customer of the network 124 such as an enterprise, organization, or individual.

The access node 122 of communication system 100 may provide communication coupling the UE 102 to the network 124 according to a 5G protocol, for example 5G, 5G New Radio, or 5G LTE radio communication protocols. The access node 122 may provide communication coupling the UE 102 to the network 124 according to a long term evolution (LTE), a code division multiple access (CDMA), and/or a global system for mobile communication (GSM) radio communication protocol. The access node 122 may be referred to for some contexts as a gigabit Node B (gNB), an enhanced Node B (eNB), a cell site, or a cell tower. Additionally, while not shown, UE 102 may be communicatively coupled to the network 124 via a WiFi access point or another non-cellular radio device. Further, while a single access node 122 is illustrated in FIG. 1, it is understood that communication system 100 may comprise any number of access nodes 122.

Network 124 comprises a plurality of interconnected data handling facilities 126 that form or define the backbone of the network 124 (with access nodes 122 forming the skin of the network 124) and which direct network traffic (e.g., traffic generated by UE 102 and/or application server 130) across the network 124 to its intended destination. Data handling facilities 126 thus include the telecommunication hardware required for directing network traffic including network servers, routers, and switches, along with equipment necessary for supporting the telecommunication hardware such as a power system for supplying adequate power to the telecommunication hardware and a cooling system for cooling the telecommunication hardware such that it may remain within a desired operational temperature range.

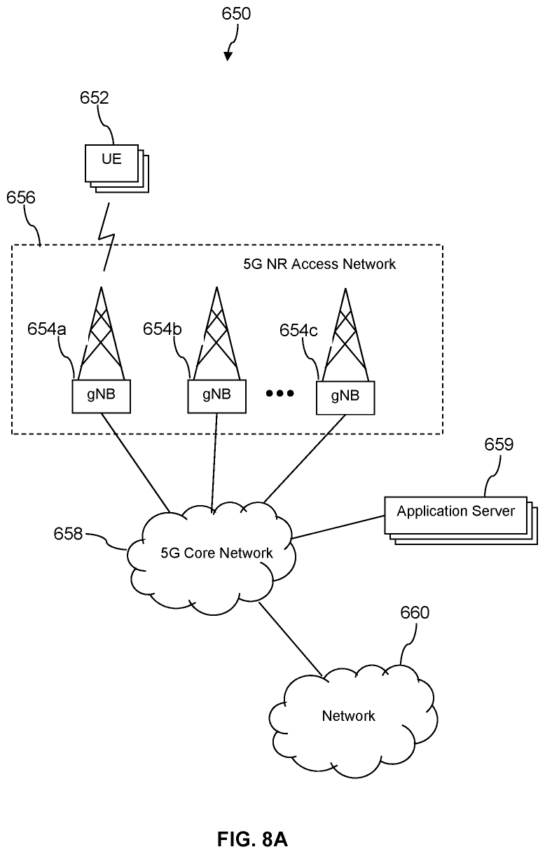

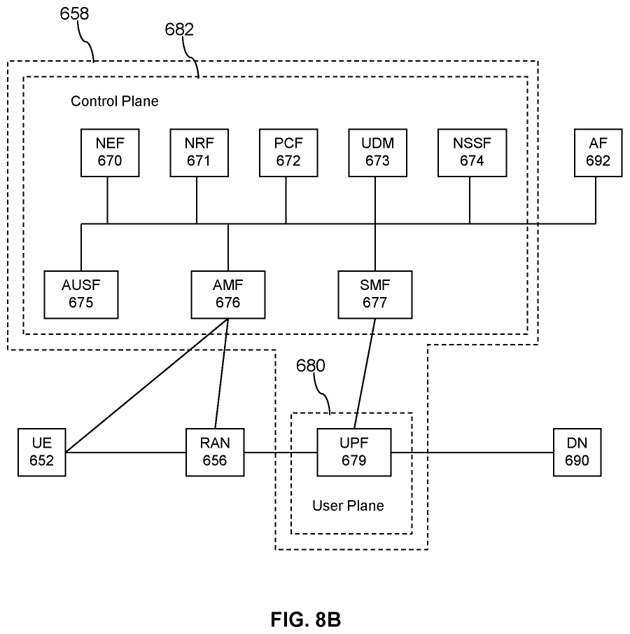

The network 124 of communication system 100 may comprise one or more public networks, one or more private networks, or a combination thereof. For example, network 124 may comprise a core network, such as a 5G core network. Further details of 5G networks are discussed below with reference to FIGS. 8A, 8B. While shown as communicatively coupled to the network 124, application server 130, datastore 140, and ontology system 160 may be considered part of network 124 and are illustrated as separate from network 124 in FIG. 1 to promote discussing their roles with respect to UE 102, as will be discussed further herein. Additionally, although in FIG. 1 network 124 is shown as including only a single datastore 140 and application server 130, it may be understood that network 124 may include varying numbers of datastores and servers.

UE 102 includes a processor or CPU 104 and a memory 106 in signal communication with the processor 104. UE 102 may access various resources of network 124 through the access node 122. For example, users of UE 102 may transmit information from UE 102 to the network 124 through the access node 122 and save the transmitted information on the network 124, such as on datastore 140. In addition, UE 102 may access at least some of the resources of the application server 130, where application server 130 may include one or more server applications 132. Server applications 132 may provide one or more services or features accessible by the user through UE 102.

The datastore 140 of communication system 100 includes a time-series network traffic dataset 142, a time-series facility power dataset 144, and one or more facility ontologies 146 corresponding to the data handling facilities 126 of network 124. Network traffic dataset 142 comprises time-series data of network throughput and/or bandwidth associated with the plurality of data handling facilities 126 of network 124. For example, network traffic dataset 142 may indicate the network load applied to one or more selected data handling facilities 126 over a selected time period (e.g., the amount of network data routed by a selected facility 126 over the selected time period).

Network traffic dataset 142 may be used to monitor the flow of network traffic over time through the different data handling facilities 126 forming the network 124. In some embodiments, network traffic dataset 142 is specific to a given data handling facility such that the network throughput through a selected data handling facility 126 may be monitored over time. In certain embodiments, network traffic dataset 142 may be specific to particular telecommunication hardware (e.g., a selected server rack, a selected network server) of a selected data handling facility 126. Network traffic dataset 142 may be captured by one or more network traffic monitoring tools of network 124 in real-time (e.g., with a latency of one minute or less, one second or less) or near real-time (e.g., updated periodically such as hourly, daily, weekly).

Facility power dataset 144 comprises time-series data of the flow of electrical power through the data handling facilities 126 over time. In some embodiments, facility power dataset 144 has a granularity sufficient to capture the flow of electrical power through the different electrically powered components of a given data handling facility 126. These electrically powered components may comprise components of a power system (e.g., a switchgear, a circuit breaker, a panel, a transformer, a rectifier) of the data handling facility 126, a cooling system (e.g., a fan or blower, an evaporator, a condenser, a chiller) of the data handling facility 126, and/or telecommunication hardware of the data handling facility such as, for example, network servers, routers, and switches. Facility power dataset 144 may be captured in real-time or near real-time by a plurality of electrical power meters or power sensors of the different data handling facilities 126 forming network 124, as will be discussed further herein.

The facility ontologies 146 of datastore 140 are generated by the ontology system 160 of communication system 100 and provide different ontologies for the data handling facilities 126 forming network 124. Particularly, facility ontologies organize or embed the facility power dataset 144 (and in some embodiments the network traffic dataset 142 as well) into a single, interrogable ontology data structure. The ontology data structure may take on different forms such as a tabular form, a graphical form, and the like.

As will be discussed further herein, facility ontologies may be multi-layered including an infrastructure layer indicating relationships between infrastructural components of a given data handling facility 126; a physical layer indicating electrical powered components and their physical connections for the data handling facilities 126; a logical layer indicating logical relationships between different components or systems of the data handling facilities 126. In certain embodiments, at least some of the facility ontologies 146 are each specific to a unique data handling facility 126 while other facility ontologies 146 may correspond to a plurality or group of data handling facilities 126. In certain embodiments, some of the facility ontologies 146 may correspond to different systems of a selected data handling facility 126. Further, in some embodiments, facility ontologies 146 map the facility power dataset 144 into topologies that may be selectably interrogated by users of the ontology system 160. In some embodiments, facility ontologies 146 may be constructed from both the facility power dataset 144 and the network traffic dataset 142 of datastore 140.

The ontology system 160 of communication system 100 is configured to generate the facility ontologies 146 stored in datastore 140 as well as to manage or interrogate (e.g., at the behest of a user of ontology system 160) the facility ontologies 146 to gain insight to the operation (or proposed future operation) of the network 124. In this exemplary embodiment, ontology system 160 includes an auto-discovery tool 162 and an ontology engine 164 including an interrogation or query tool 166.

The auto-discovery tool 162 of ontology system 160 discovers automatically the physical connections between electrically powered components of data handling facilities 126 based on the facility power dataset 144. In some embodiments, ontology system 160 discovers automatically the physical connections (e.g., electrical physical connections) between electrically powered components (e.g., components of power systems, cooling systems, telecommunication hardware) of data handling facilities 126 using only information gleaned or sourced from the facility power dataset 144, and thus does not make use of other sources of information such as engineering drawings that may be incorrect or incomplete. The physical connections discovered by auto-discovery tool 162 may be captured in the facility ontologies 146 stored in datastore 140.

The ontology engine 164 of ontology system 160 automatically generates and manages the facility ontologies 146 stored in datastore 140 using the physical connections discovered by the auto-discovery tool 162 and the facility power dataset 144. In some embodiments, ontology engine 164 automatically generates and manages the facility ontologies 146 stored in datastore 140 using the physical connections discovered by the auto-discovery tool 162 and the facility power dataset 144.

The facility ontologies 146 generated by ontology engine 164 capture more than the physical connections between electrically powered components of data handling facilities 126. Particularly, ontology engine 164 builds or interleaves additional ontology layers onto the physical ontology mapped out by the auto-discovery tool 162. These additional ontology layers pertain to the infrastructure of the data handling facilities 126 (e.g., mapping out the relationship between different floors, rooms, and other infrastructural components of a data handling facility 126 with electrically powered components thereof). Additionally, ontology engine 164 may generate additional ontology layers such as a logical ontology layer defining logical relationships between different components (e.g., infrastructural components, electrically powered components, systems or subsystems) of the data handling facilities 126 which may be leveraged using the query tool 166 of ontology engine 164 to gain greater insight to the operation of the different data handling facilities 126 of network 124.

In some embodiments, using the facility power dataset 144, ontology engine 164 may additionally classify in accordance with a predefined taxonomy different electrically powered components of the data handling facilities 126. In other words, based on how electrical power flows into and from a given electrically powered component over time, ontology engine 164 may infer a classification for the electrically powered component. The taxonomy may include different classifications of electrically powered components found in power systems, cooling systems, and/or telecommunication hardware of data handling facilities 126. For example, the classifications of the predefined taxonomy may include electrical transformers, electrical switching devices, electrical panels or subpanels, electrical rectifiers, air conditioner compressor motors, air conditioner fan motors, server racks, and the like. For instance, based on a substantial change in electrical voltage across a given electrically powered component of a data handling facility 126, the ontology engine 164 may infer the component is an electrical transformer having capabilities defined by the monitored flow of electrical power into and from the electrical transformer documented in the facility power dataset 144. In this manner, the different electrically powered components of data handling facilities 126 may be classified automatically without needing to rely on other sources of information such as engineering drawings that may be inaccurate, outdated, and/or incomplete.

The query tool 166 of ontology engine 164 permits users of ontology system 160 to query or interrogate the facility ontologies 146 generated by the ontology engine 164. For example, a user may use the query tool 166 to correlate network traffic with power consumption within a given data handling facility 126 to gain greater insight into the operation of the data handling facility 126 such as how much excess network bandwidth, power capacity, and/or cooling capacity (inferred by the consumption of electrical power by a cooling system of the data handling facility 126) the data handling facility 126 may have during normal operation of the network 124.

In addition, query tool 166 permits users of ontology system 160 to forecast how changes to the network 124 may result in changes to the operation of data handling facilities 126. As one example, query tool 166 may allow a user to forecast, using the ontology engine 164, the impact of a utility electrical transformer crashing at a given data handling facility 126 in terms of the impact to other components of the facility 126 associated (e.g., physically or logically connected) to the downed transformer as well the larger impact to the overall operation of network 124. For instance, users may determine whether the crashing of the transformer of the data handling facility 126 would result in a loss of service to users of communication system 100 due to a forecasted shortfall in network bandwidth as a result of the crashing of the transformer (e.g., based on a forecast by ontology engine 164 of the crashing of the transformer resulting in the data handling facility 126 being taken offline).

Query tool 166 may also be used to forecast (via the ontology engine 164) the impact of hypothetical modifications to one or more of the data handling facilities 126 on the operation of the data handling facilities 126. For example, query tool 166 may be used to forecast the impact of adding additional server racks (or other telecommunication hardware) to a given data handling facility 126 such as whether a power or cooling shortfall would occur at the data handling facility 126 in response to the addition of the server racks. As another example, query tool 166 may be used to study the impact of modifying the power system and/or cooling system of a given data handling facility 126 on the operation of telecommunication hardware of the data handling facility 126 (e.g., how much additional cooling capacity would be added by providing a cooling system of a data handling facility 126 with an additional air handler).

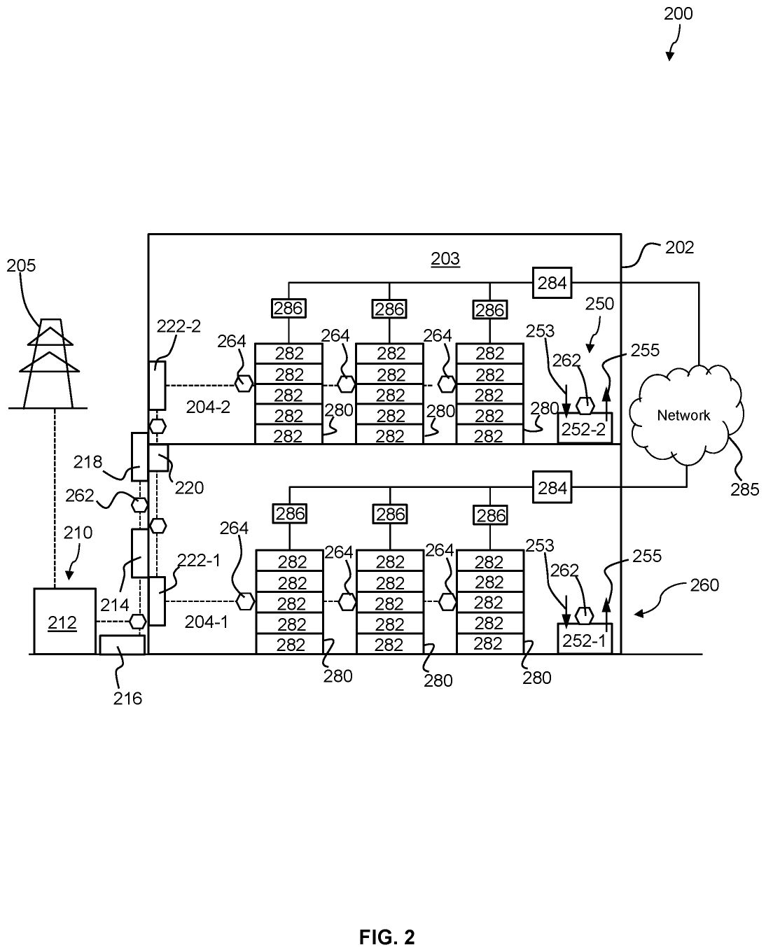

Referring now to FIG. 2, an exemplary data handling facility 200 is illustrated schematically according to some embodiments. Particularly, data handling facility 200 includes a physical infrastructure 202, a power delivery or simply “power” system 210, a cooling system 250, and a power monitoring system 260. In this exemplary embodiment, the physical infrastructure 202 of data handling facility 200 is in the form of a stationary building (and thus infrastructure 202 is also referred to herein as building 202) having a relatively fixed space capacity that is divided between a first floor 204-1 and a second floor 204-2 located vertically above the first floor 204-1. The configuration of physical infrastructure 202 may vary in other embodiments and thus building 202 serves only as one example of how the physical infrastructure of a given data handling facility may manifest. For example, in other embodiments, building 202 may comprise a single floor 204 or more than two floors 204. In still other embodiments, physical infrastructure 202 may not comprise a stationary building having a relatively fixed physical space capacity and instead may comprise a mobile and/or modular infrastructure.

Data handling facility 200 additionally includes telecommunication hardware that is divided between floors 204-1 and 204-2. Particularly, on each floor 204 is positioned a plurality of sever racks 280 each comprising a plurality of network servers 282 (e.g., blade servers). Network servers 282 may be implemented as computer systems. Computer systems are described further herein. In addition, the telecommunication hardware of data handling facility 200 includes one or more routers 284 and one or more network switches 286 connected between the network routers 284 and the server racks 280. Network routers 284 of data handling facility 200 are connected to a network 285 (e.g., network 124 illustrated in FIG. 1). For example, network routers 284 of data handling facility 200 may be connected with the telecommunication hardware of other data handling facilities 200 where a plurality of interconnected data handling facilities 200 at least partially collectively form the backbone or core of the network 285 for directing network traffic therealong.

Network servers 282 of the server racks 280 of data handling facility 200 facilitate various functionalities and features of the network 285. Network servers 282 are connected to the larger network 285 through the network routers 284 of data handling facility 200. Additionally, individual server racks 280 may be selectably isolated from the network 285 via the operation of network switches 286. In some embodiments, individual network servers 282 of a selected server rack 280 may be isolated from the network 285 via the operation of one or more network switches 286.

In some embodiments, one or more network servers 282 may comprise application servers hosting one or more server applications (e.g., application servers 130 hosting server applications 132 illustrated in FIG. 1). One or more of network servers 282 may be responsible for properly routing network traffic to ensure users of the network 285 may access desired features hosted on the network 285. Further, one or more network servers 282 may comprise data servers hosting one or more datastores (e.g., datastore 140 illustrated in FIG. 1) of the network 285. Although in this exemplary embodiment the telecommunication hardware of data handling facility 200 includes server racks 280, network routers 284, and network switches 286, the composition and/or configuration of the telecommunication hardware may vary in other embodiments from that shown in FIG. 2. For example, in other embodiments, the telecommunication hardware of data handling facility 200 may include sensor arrays, data acquisition systems, control architecture, and other computer-implemented hardware.

The telecommunication hardware (e.g., server racks 280, network routers 284, and network switches 286) consume electrical power in order to perform their intended functions, said electrical power being delivered to the telecommunication hardware by the power system 210 of data handling facility 200. In this exemplary embodiment, power system 210 of data handing facility 200 generally includes an electrical transformer 212, a switchgear 214, an electrical generator 216, an uninterruptible power supply (UPS) 218, a power distribution unit (PDU) 220, and one or more power supplies 222.

The transformer 212 of power system 210 receives high voltage alternating current (HV-AC) electrical power from an electrical grid 205 connected therewith. Transformer 212 serves to reduce or “step down” the AC voltage of the HV-AC used to transmit the electrical power through the electrical grid 205 (e.g., to minimize transmission losses) to a lesser voltage that may be safely and conveniently handled by the components of power system 210. The stepped down AC voltage electrical power is outputted by the transformer 212 and transferred to the switchgear 214 which, in this exemplary embodiment, comprises an AC switchgear. Switchgears such as switchgear 214 comprise electrical switching devices configured to distribute electrical power to a plurality of selectable outputs from a single electrical power input received by the electrical switching device. Electrical switching devices such as switchgears (a high-voltage electrical switching device) typically include electrical busses or busbars, switches, circuit breakers, fuses, and the like.

In addition to transformer 212, electrical generator 216 is also connected to switchgear 214. Particularly, in this exemplary embodiment, electrical generator 216 is configured to produce electrical power (e.g., AC electrical power) that is deliverable to the switchgear 214. For example, electrical generator 216 may include an engine powered by a fuel source (e.g., natural gas) for selectably driving the operation of electrical generator 216. Thus, in this exemplary embodiment, switchgear 214 may receive electrical power from electrical grid 205 (via the transformer 212) and/or from electrical generator 216. In other embodiments, power system 210 may not include electrical generator 216 with electrical grid 205 being the only source of electrical power for data handling facility 200. In still other embodiments, data handling facility 200 may be provisioned with additional sources of electrical power such as a solar array and the like.

Switchgear 214 serves as an electrical switching device for electrically isolating data handling facility 200 from the sources of electrical power (electrical grid 205 and electrical generator 216 in this exemplary embodiment) configured to supply data handling facility 200 with electrical power. Thus, by operating switchgear 214, data handling facility 200, including the telecommunication hardware thereof, may be electrically isolated from the electrical grid 205.

The UPS 218 receives electrical power from the switchgear 214 when the switchgear 214 is in a “closed” state electrically connecting the UPS 218 with the transformer 212 and electrical generator 216. UPS 218 is generally configured to provide a reliable, uninterrupted flow of electrical power to the telecommunication hardware (e.g., server racks 280, network routers 284, and network switches 286) of data handling facility 200. Additionally, UPS 218 provides an uninterrupted flow of electrical power to the cooling system 250 of data handling facility 200. In some embodiments, UPS 218 is configured to store backup electrical power (e.g., via batteries of the UPS 218) for providing the data handling facility 200 with electrical power in the event that the normal sources of electrical power (e.g., electrical grid 205 and/or electrical generator 216) become unavailable so that the distribution of power to the telecommunication hardware and/or cooling system 250 of data handling facility 200 is not interrupted. However, UPS 218 may only store a finite amount of electrical power and thus continued operation of the electrically powered equipment of data handling facility 200 is contingent upon one of the normal sources of electrical power for data handling facility 200 being restored before the backup power supplied by UPS 218 has been consumed.

The PDU 220 of power system 210 distributes electrical power received from the UPS 218 of power system 210 to various electrically powered equipment of data handling facility 200. In this exemplary embodiment, PDU 220 distributes AC electrical power to a pair of power supplies 222-1, 222-2, and the cooling system 250 of data handling facility 200. Power supplies 222-1 and 222-2 of power system 210 convert the AC electrical power received thereby from PDU 220 into DC electrical power that is supplied to the telecommunication hardware (e.g., server racks 280, network routers 284, and network switches 286) of data handling facility 200.

In this exemplary embodiment, each floor 204-1 and 204-2 of building 202 is provided with its own power supply 222-1 and 222-2, respectively, for powering the telecommunication hardware located on the given floor 204-1 and 204-2. However, the composition and configuration of the components of power system 210 may vary in other embodiments. For example, in other embodiments, a single power supply 222 may power the telecommunication hardware for both floors 204-1 and 204-2. In other embodiments, each server rack 280 may have its own unique power supply 222. In still other embodiments, power system 210 may not include electrical generator 216 and/or UPS 218.

Further, power system 210 comprises an AC power system in this exemplary embodiment such that the AC electrical power received by power system 210 is only converted to DC electrical power at the last instance when the electrical power is supplied to the DC electrically powered equipment of data handling facility 200. However, in other embodiments, power system 210 may comprise a DC power system including a DC rectifier positioned between the given power source (e.g., electrical grid 205) and the switchgear for converting the AC electrical power received from the power source into DC electrical power upstream of the switchgear. In this configuration, the switchgear would receive DC electrical power from the DC rectifier. At least some of the network switches 286 and network routers 284 may receive DC electrical power.

During operation of data handling facility 200, the telecommunication hardware (e.g., server racks 280, network routers 284, and network switches 286) thereof may consume substantial amounts of electrical power supplied by the power system 210. At least a portion of the electrical power consumed by the telecommunication hardware of data handling facility 200 is converted into thermal energy that radiates from the telecommunication hardware through an interior 203 of the building 202 of data handling facility 200.

Given that the telecommunication hardware of data handling facility 200 may consume substantial amounts of electrical power, the telecommunication hardware may similarly generate substantial amounts of heat during the operation of data handling facility 200. Indeed, the heat generated by the telecommunication hardware may, without adequate cooling, lead to overheating (e.g., operate at a temperature falling outside of an operational temperature range of the hardware) of at least some of the telecommunication hardware such that the hardware may be at risk of incurring damage or otherwise at risk of not performing as intended. Cooling system 250 of data handling facility 200 thus provides cooling to the interior 203 of building 202 sufficient to adequately cool the telecommunication hardware located therein and prevent the telecommunication hardware from overheating.

In this exemplary embodiment, cooling system 250 is configured to implement a closed-loop refrigeration cycle in which heat (e.g., heat generated by the server racks 280, network routers 284, and network switches 286 of data handling facility 200) is pumped from the interior 203 of building 202 to the ambient environment surrounding the building 202. Particularly, in this exemplary embodiment, cooling system 250 includes a pair of computer room air conditioning (CRAC) units 252-1 and 252-2 divided between the floors 204-1 and 204-2 of building 202. Each CRAC unit 252-1 and 252-2 comprises an evaporator fluidically coupled with a condenser or cooler that is external the building 202. In this configuration, each CRAC unit 252-1/252-2 receives a stream of hot air 253 that is cooled by the evaporator of the CRAC unit 252-1/252-2 and rejected from the CRAC unit 252-1/252-2 as cooled air 255. Particularly, heat from the hot air 253 is transferred to coolant circulating through the evaporator and which may be pumped to a condenser located external the building 202 where the heat is transferred from the condenser to the ambient air of the external environment.

While in this exemplary embodiment cooling system 250 is configured to implement a closed-loop, mechanical refrigeration cycle, the configuration of cooling system 250 may vary in other embodiments. For example, in some embodiments, cooling system 250 may include one or more computer room air handlers (CRAHs) that do not make use of mechanical refrigeration.

Each CRAC unit 252-1/252-2 may have a corresponding cooling capacity (e.g., measured in kWs) that is contingent on the configuration (e.g., the size of the evaporator, blower, and/or condenser, the volume or type of refrigerant, and other factors) of the respective CRAC unit 252-1/252-2. In addition to a cooling capacity, each CRAC unit 252-1/252-2 may have a corresponding efficiency based on the configuration of the respective CRAC unit 252-1/252-2 that relates the amount of cooling that the CRAC unit 252-1/252-2 provides for a given amount of input power (e.g., AC electrical power measured in kWs) consumed by the CRAC unit 252-1/252-2. For instance, based on the efficiency of a given CRAC unit (or other cooling unit of cooling system 250), an amount of cooling provided by the CRAC unit may be estimated based on the amount of input power consumed by the CRAC unit over a given period of time.

The power monitoring system 260 of data handling facility 200 monitors different parameters of the data handling facility 200, particularly with respect to the flow of power and data signals through the data handling facility 200. In some embodiments, power monitoring system 260 is communicatively coupled to the network 285 permitting remote monitoring of the data handling facility 200 through the power monitoring system 260. In certain embodiments, power monitoring system 260 may provide real-time or near real-time monitoring information to a user located either onsite at the data handling facility 200 or located remotely via the network 285.

In this exemplary embodiment, power monitoring system 260 includes a plurality of power sensors (e.g., current sensors) for monitoring power consumption (e.g., electrical power consumption in kWs) over time. In this exemplary embodiment, power monitoring system 260 includes a plurality of AC power monitors 262 and a plurality of DC power monitors 264. AC power monitors 262 are connected between the different AC-powered components of power system 210 including, for example, transformer 212, switchgear 214, generator 216, UPS 218, PDU 220, and power supplies 222. DC power monitors 264 are linked to specific pieces of telecommunication hardware of data handling facility 200 such that the electrical power consumed by the respective telecommunication hardware may be individually monitored over time.

At least some of the AC power monitors 262 may comprise preexisting equipment installed, e.g., during the original construction of data handling facility 200. Alternatively, at least some of the AC power monitors may be equipment installed specifically for the purpose of enabling the functionality of an ontology system. The AC power monitors 262 monitor one or more parameters pertaining to the AC electrical power flowing through the given AC power monitor 262. For example, AC power monitors 262 may monitor AC current and voltage over time (e.g., associating the monitored AC current and voltage with a timestamp). In some embodiments, at least some of the AC power monitors 262 may monitor additional parameters including, for example, frequency, phasing, voltage distortion, and the like.

The DC power monitors 264 of power monitoring system 260 are connected between the different DC-powered components of data handling facility 200 including the telecommunication hardware thereof such as, for example, network servers 282, network routers 284, and network switches 286. At least some of the DC power monitors 264 may comprise preexisting equipment installed, e.g., during the original construction of data handling facility 200. Alternatively, at least some of the DC power monitors may be equipment installed specifically for the purpose of enabling the functionality of an ontology system. The DC power monitors 264 monitor one or more parameters pertaining to the DC electrical power flowing through the given DC power monitor 264. For example, DC power monitors 264 may monitor DC current and voltage over time.

AC power monitors 262 permit the monitoring of the flow of AC electrical power through the data handling facility 200. For example, AC power monitors 262 may be positioned to measure or monitor the amount of electrical power flowing into the UPS 218 of power system 210 over time. In this manner, the AC power monitors 262 may monitor the total amount of electrical power consumed by the digital handling facility (e.g., from electrical grid 205 and/or electrical generator 216) over time.

In addition to the above, one or more of the AC power monitors 262 may be positioned to monitor the amount of power consumed by cooling system 260 over time. For example, one or more of the AC power monitors 262 may be individually linked to or correspond with a unique CRAC unit 252-1/252-2. In this manner, a user (locally or remotely) may monitor, using the AC power monitors 262, the amount of electrical power individually consumed by CRAC units 252-1/252-2 over time. The amount of power consumed by CRAC units 252-1/252-2 over time may provide insight into the amount of cooling required for the data handling facility 200 and the ability of cooling system 250 in meeting those requirements over time. For example, the amount of cooling delivered by cooling system 250 over time may be estimated based on the monitored power consumed by CRAC units 252-1/252-2 and the known efficiencies of the CRAC units 252-1/252/2.

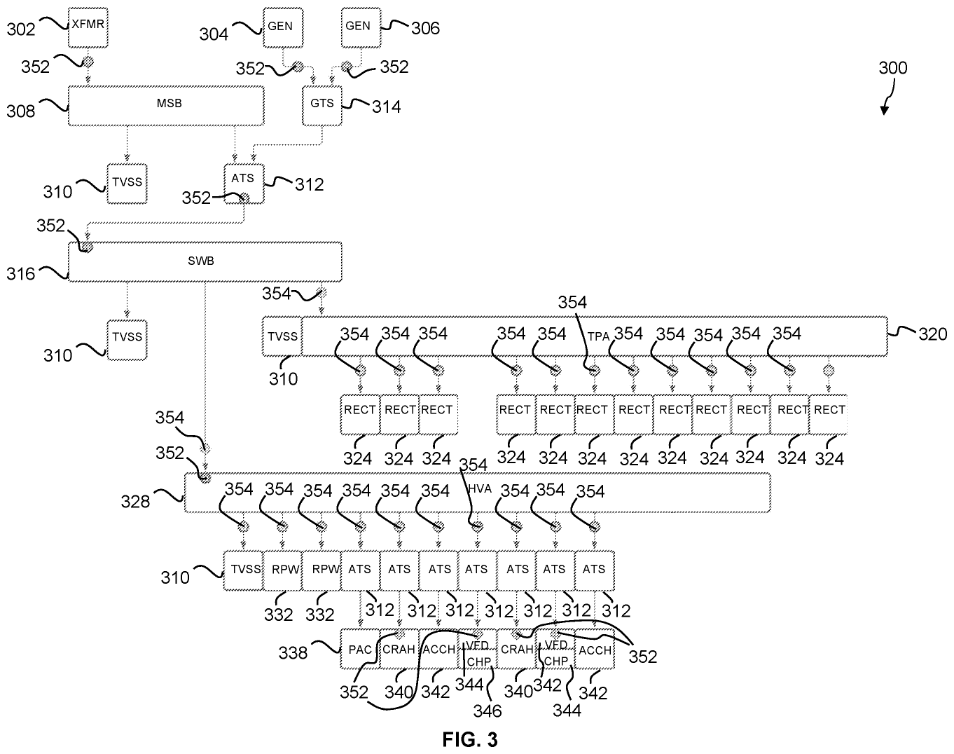

Referring now to FIG. 3, a one-line diagram illustrating a power system 300 of a data handling facility (e.g., one of data handling facilities 126 illustrated in FIG. 1) is shown. The data handling facility ontology of FIG. 3 includes at least some of the AC-powered components of the power system 300 of a data handling facility. In this exemplary embodiment, power system 300 includes a transformer 302, a portable generator connection 304, and a generator set or “genset” 306. Transformer 302 receives AC electrical power from an electrical grid (e.g., electrical grid 205 illustrated in FIG. 2) while generator connection 304 provides an electrical connection to an auxiliary, portable generator and genset 306 is configured to produce AC electrical power during operation.

In this exemplary embodiment, AC electrical power from transformer 302 is connected via an electrical switching device in the form of a master switch board (MSB) 308. MSB 308 is connected to a transient voltage surge suppressor (TVSS) 310 and an automatic transfer switch (ATS) 312. In this configuration, AC electrical power may flow from the MSB 308 to the ATS 312 for distribution therefrom. In addition, generator connection 304 and genset 306 are each electrically connected to a generator transformer switch (GTS) 314 that is electrically connected, in-turn, to the ATS 312. In this configuration, AC electrical power may flow from the MSB 308 and/or the GTS 314 to the ATS 312.

Power system 300 additionally includes additional electrical switching devices in the form of a switchboard (SWB) 316, a TPA fuse panel 320, and a high-voltage switchboard (HVA) 328. SWB 316 is electrically connected and receives AC electrical power from the ATS 312 connected to both MSB 308 and GTS 314. In-turn, SWB 316 is electrically connected and supplies AC electrical power to both the TPA fuse panel 320 and the HVA 328, where each of the SWB 316, TPA fuse panel 320, and HVA 328 are connected to a dedicated TVSS 310 connected to ground.

The TPA fuse panel 320 is electrically connected with and supplies AC electrical power to a plurality of rectifiers 324 and which convert the received AC electrical power into DC electrical power for powering telecommunication hardware of the data handling facility that is connected to the respective rectifier 324. In some instances, rectifiers 324 may form a component of a power supply of a given piece of telecommunication hardware.

The HVA 328 is electrically connected with and provided AC electrical power to one or more protective relays 332 and a plurality of ATSs 312. In-turn, ATSs 312 electrically connected to HVA 328 are electrically connected with, and provide AC electrical power to a packaged air conditioner (PAC) 338, one or more computer room air handlers (CRAHs) 340, one or more variable frequency drives (VFDs) 344 and corresponding one or more combined heat and power systems (CHPs) 346 connected therewith, an air cooled chiller (ACCH) 342. Thus, the HVA 328 electrically powers the heating, ventilation, and air conditioning (HVAC) equipment of the data handling facility including the equipment used to cool the telecommunication hardware thereof (e.g., CRAHs 340, ACCH 342).

In addition to the components discussed above, power system 300 identifies the locations of power sensors or monitors of the data handling facility. Particularly, in this exemplary embodiment, power system 300 indicates a plurality of pre-existing power meters 352 and a plurality of power monitors 354 installed at the data handling facility to facilitate the generation of power system 300. Power meters 352 and power monitors 354 may monitor one or more different parameters of the AC electrical power circulated through the given power meter 352 or power monitor 354. For instance, power meters 352 and/or power monitors 354 may monitor voltage, current, power, frequency, and/or phase.

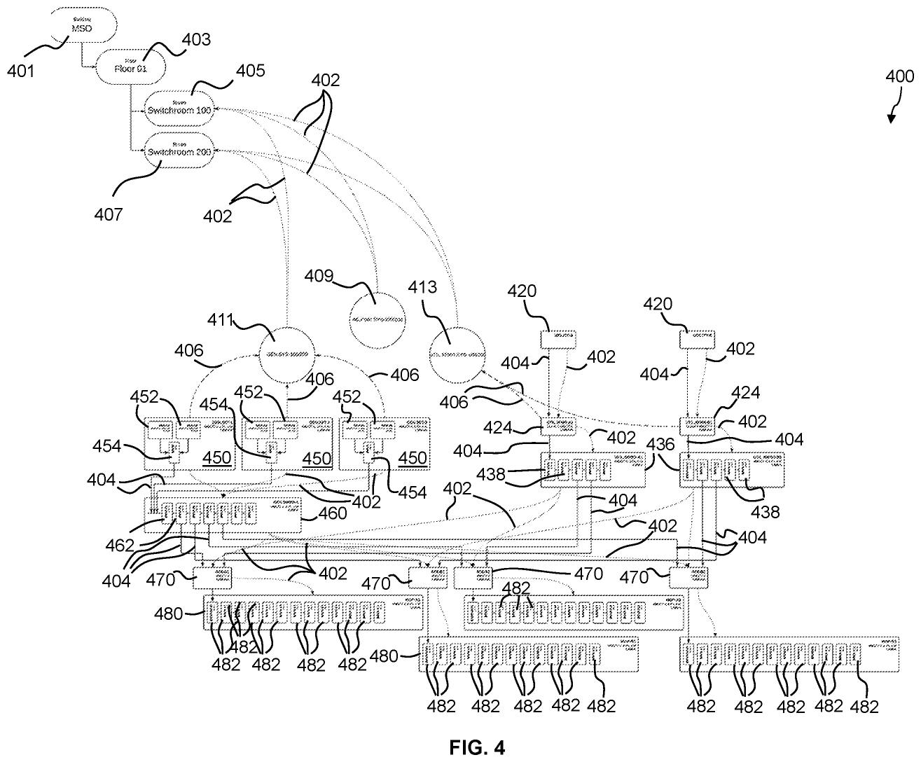

Referring now to FIG. 4, an example of a data handling facility ontology 400 (or simply “facility ontology 400”) of a data handling facility (e.g., one of data handling facilities 126 illustrated in FIG. 1) is shown. Particularly, facility ontology 400 is shown in FIG. 4 in the form of a graphical data structure such as a knowledge graph. Facility ontology 400 includes a multi-layered topology or map of the data handling facility generated from data acquired by a power monitoring system of the data handing facility. Facility ontology 400 is a data structure including a plurality of nodes connected by directional (e.g., having a specific direction) edges, where some of the nodes comprise physical nodes corresponding in a one-to-one relationship with a given electrically powered component of the data handling facility. Additionally, facility ontology 400 includes logical nodes that are purely logical and thus does not correspond to a unique electrically powered component (e.g., the node and the electrically powered component exist in a one-to-one relationship).

In this exemplary embodiment, facility ontology 400 includes a physical building or facility node 401, a physical floor node 403, a first physical room node 405, and a second physical room node 407. Physical building node 401 corresponds physically to the building of the data handling facility (e.g., building 202 of data handling facility 200 illustrated in FIG. 2). Physical floor node 403 corresponds physically to a given floor of the building of the data handling facility (e.g., floor 204-1 of data handling facility 200 illustrated in FIG. 2). Finally, physical room nodes 405 and 407 correspond physically to two different rooms located on the floor corresponding to physical floor node 403 and thus it may be surmised that the rooms of physical room nodes 405 and 407 are located on the same floor of the data handling facility.

The oval-shaped physical nodes 401, 403, 405, and 407 of facility ontology 400 are specialized type of physical node corresponding to an infrastructure ontology of the data facility that correspond directly in a one-to-one relationship with infrastructural components (e.g., buildings, floors, rooms, server racks) of the data handling facility. Thus, physical nodes 401, 403, 405, and 407 may also be referred to herein as infrastructure nodes 401, 403, 405, and 407 which collectively define an infrastructure ontology layer of the facility ontology 400.

Nodes of facility ontology 400 may be connected together physically and/or logically. Particularly, facility ontology 400 includes a plurality of directional logical connections or edges 402 (logical edges 402 are labeled in FIG. 4 only where space permits) and a separate plurality of directional physical connections or edges 404 (physical edges 404 are labeled in FIG. 4 also only where space permits). A logical edge 402 connected between a pair of nodes of facility ontology 400 indicates a logical or functional connection between the pair of components corresponding to the respective pair of nodes such that the operation of a first electrically powered component is contingent on the operation of a second electrically powered component logically related to the first electrically powered component and vice-a-versa. For instance, a change in the operation of one of the components of the pair of components may impact the operation of the other component of the pair of components and so on and so forth. Logical edges 402 may be connected between a pair of physical nodes, a pair of logical nodes, or one physical node and one logical node. Conversely, physical edges 404 of facility ontology 400 are connected only between pairs of physical nodes and indicate a physical connection between the pair of components corresponding to the respective pair of physical nodes. Generally, physical edges 404 in FIG. 4 represent electrical connections formed between various nodes of facility ontology 400.

Some nodes of facility ontology 400 may be logically connected with other nodes without being physically connected (e.g., via a physical edge 404) therewith. For example, facility ontology 400 includes logical nodes 409, 411, and 413, each of which is logically connected via a logical edge 402 to logical room nodes 405 and 407 but, being logical nodes, are not physically connected to the rooms corresponding to logical room nodes 405 and 407. Particularly, in this exemplary embodiment, logical node 409 comprises an AC power system node 409 representing the AC power system of the data handling facility (e.g., the power system 210 of data handling facility 200 illustrated in FIG. 2. Additionally, in this exemplary embodiment, logical node 411 comprises a genset system node 411 logically connected to each of the logical room nodes 405 and 407 via corresponding logical edges 402. Genset system node 411 defines logically a genset system of the data handling facility. Particularly, the logical edges 402 connecting the genset system node 411 indicate that genset system node 411 (or the electrically powered components corresponding to node 411) service both of logical room nodes 405 and 407 and thus a failure of the genset system node 411 may impact the performance of both of the logical room nodes 405 and 407 of the logical floor node 403 but not any other room nodes or floor nodes of the given data handling facility.

Further, logical node 413 comprises a logical utility transformer system node 413 corresponding to a utility transformer system of the data handling facility and which is connected logically to the pair of logical room nodes 405 and 407 via two corresponding logical edges 402. In this exemplary embodiment, facility ontology 400 includes a pair of physical utility nodes 420 corresponding to electrical connections of the data handling facility with an electrical grid for supplying AC electrical power to the data handling facility. Facility ontology 400 additionally includes a pair of physical utility transformer nodes 424 that are physically (e.g., electrically) connected to the pair of utility nodes 420 via a pair of physical edges 404. In addition, utility transformer nodes 424 are logically connected to the pair of utility nodes 420 by a pair of logical edges 402 indicating that operation of the utility transformer nodes 424 is contingent on the operation of utility nodes 420. Thus, each utility 420 is physically and logically connected to a corresponding utility transformer node 424 of the facility ontology 400. Thus, disruptions of operation to one of the utilities 420 may logically impact the operation of the utility transformer node 424 logically connected therewith (e.g., the utility transformer may cease operation in response to a loss of power from the logically connected utility or electrical grid).

The pair of utility transformer nodes 424 are connected to the utility transformer system node 413 by specialized logical edges referred to herein as directional system connections or edges 406. System edges 406 indicate that pairs of electrically powered components connected thereby logically form components of the same system of the data handling facility. For instance, system edges 406 connecting utility transformer nodes 424 with utility transformer system node 413 indicate that both utility transformer nodes 424 are part of the same utility transformer system of the data handling facility represented by the utility transformer system node 413. In some embodiments, the system edges 406 of facility ontology may collectively define (along with their corresponding system nodes) a system ontology layer of the facility ontology 400 that is separate and distinct from the physical ontology layer (collectively defined by physical edges 404 and their physical nodes), the infrastructure ontology layer, and the logical ontology layer (collectively defined by logical edges 402).

In this exemplary embodiment, a first utility transformer node 424 connects both physically and logically to a first electrical switching device in the form of a physical utility switchgear node 436 while the second first utility transformer node 424 connects both physically and logically to a second electrical switching device in the form of a physical utility switchgear node 436. Each utility switchgear node 436 comprises a plurality of circuit breakers represented in facility ontology by physical breaker nodes 438. The physical edges 404 connecting utility transformer nodes 424 with utility switchgear nodes 436 indicates the specific physical connection formed between these electrically powered components and thus the physical edges 404 connect with specific breaker nodes 438 of utility switchgear nodes 436 instead of the utility switchgear nodes 436 themselves. Conversely, logical edges 402 indicate that the operation of utility switchgear nodes 436 is contingent on the operation of utility transformer nodes 424 and thus these electrically powered components are logically related to one another.

Returning to genset system node 411, node 411 is connected by system edges 406 to a plurality of physical genset nodes 450 indicating that the genset nodes 450 are part of the same genset system of the data handling facility as represented by the genset system node 411 of facility ontology 400. In this exemplary embodiment, each genset node 450 includes a pair of physical electrical generator nodes 452 and a physical breaker node 454 physically connected to both electrical generator nodes 452. System edges 406 connect the genset nodes 450 as a whole to genset system node 411 given that edges 406 indicate logical relationships between these components, while, in this exemplary embodiment, the breaker nodes 454 of genset nodes 450 are physically connected by physical edges 404 to an electrical switching device in the form of a physical generator switchgear node 460 that comprises a plurality of breakers represented by breaker nodes 462.

Particularly, the breaker nodes 454 of genset nodes 450 are physically connected to a bus bar of the generator switchgear node 460 that is electrically connected to the breaker nodes 462 thereof. In addition, each genset node 450 is logically connected by logical edges 402 to the generator switchgear node 460 to indicate a logical relationship between these electrically powered components such that operation of the generator switchgear node 460 is contingent on the operation of each of the genset nodes 450.

Facility ontology 400 additionally includes a plurality of physical ATS nodes 470 connected physically by physical edges 404 with the breaker nodes 438 and 462 of the switchgear nodes 436 and 460, respectively. Additionally, the physical ATS nodes 470 are logically connected via logical edges 402 with the different switchgear nodes 436 and 460 to indicate the logical or functional relationships between these electrically powered components. Further, facility ontology 400 includes a plurality of physical switchboard nodes 480 comprising a plurality of breaker nodes 482 some of which are connected physically by physical edges 404 with the ATS nodes 470. Additionally, the switchboard nodes 480 are logically connected via logical edges 402 with the different ATS nodes 470 to indicate the logical or functional relationships between ATS nodes 470 and switchboard nodes 480.

Although facility ontology 400 is shown as comprising a singular, graphical data structure, it may be understood that the form of the data structure which facility ontology 400 takes may vary from that shown in FIG. 4. For example, in some embodiments, facility ontology 400 may be in the form of a database or other non-graphical data structure. Additionally, the data structure forming facility ontology 400 may be interrogated by a query tool (e.g., query tool 166 shown in FIG. 1) so that users of the facility ontology 400 may gain further insight into the operation of the data handling facility represented by facility ontology 400. For example, a user may, using an ontology engine (e.g., ontology engine 164 shown in FIG. 1) query the facility ontology 400 to understand the impact to the operation of the data handling facility of one of the genset nodes 450 being taken offline. For instance, what impact to other nodes of facility ontology 400 would occur from one of the genset nodes 450 being taken offline? Would a power capacity shortfall occur at the data handling facility in response to the genset node 450 being taken offline? Would a cooling capacity shortfall occur (e.g., due to loss of power to components of a cooling system of the data handling facility) in response to the genset node 450 being taken offline? In some embodiments, these forecasts may be extended to the entire network comprising the data handling facility such as, for example, forecasted impacts to the flow of network traffic through the network in response to the genset node 450 being taken offline (or in response to other modifications to the operation of the data handling facility).

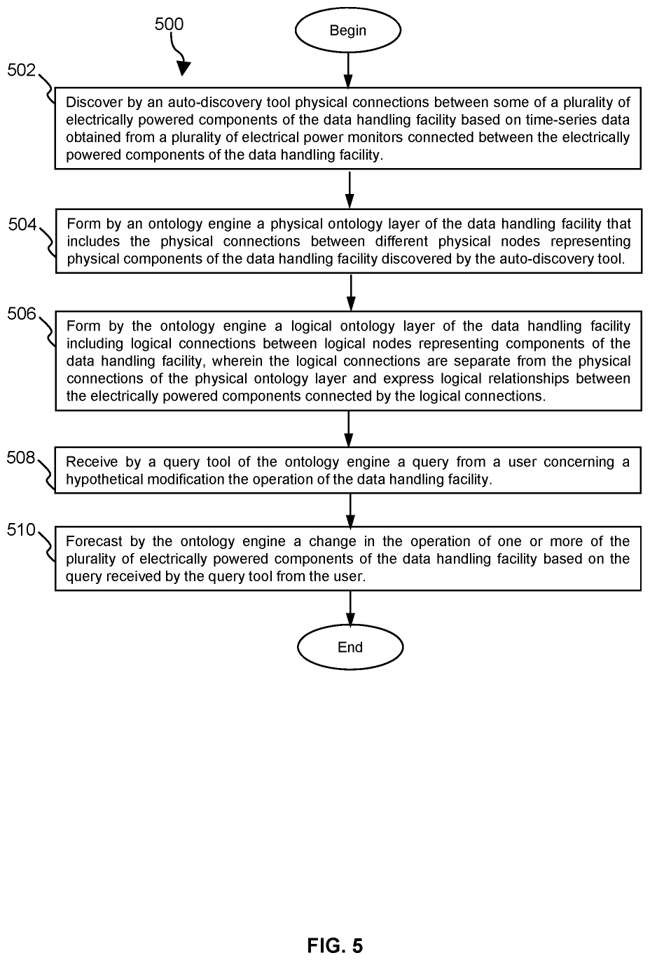

Turning to FIG. 5, a method 500 is described. In an embodiment, the method 500 is a method for managing an ontology (e.g., facility ontology 400 illustrated in FIG. 4) of a data handling facility (e.g., data handling facilities 126 illustrated in FIG. 1 and/or data handling facility 200 illustrated in FIG. 1) of a communication system (e.g., communication system 100 illustrated in FIG. 1). Method 500 may also be said to comprise a method of operating and/or maintaining a data handling facility and/or a communication system. At block 502, method 500 comprises discovering by an auto-discovery tool (e.g., auto-discovery tool 162 illustrated in FIG. 1) physical connections between some of a plurality of electrically powered components (e.g., electrically powered components illustrated in FIGS. 2-4) of the data handling facility based on time-series data (e.g., facility power dataset 144 illustrated in FIG. 1) obtained from a plurality of electrical power monitors (e.g., power monitors 262, 264 illustrated in FIG. 2 and/or power monitors 352 and 354 illustrated in FIG. 3) connected between the electrically powered components of the data handling facility.

At block 504, method 500 comprises forming by an ontology engine (e.g., ontology engine 164 illustrated in FIG. 1) a physical ontology layer of the data handling facility that includes the physical connections (e.g., physical edges illustrated in FIG. 4) between different physical nodes (e.g., physical nodes illustrated in FIG. 4) representing physical components of the data handling facility discovered by the auto-discovery tool. At block 506, method 500 comprises forming by the ontology engine a logical ontology layer of the data handling facility including logical connections (e.g., logical edges 402 illustrated in FIG. 4) between logical nodes (e.g., logical nodes illustrated in FIG. 4) representing components of the data handling facility, wherein the logical connections are separate from the physical connections of the physical ontology layer and express logical relationships between the electrically powered components connected by the logical connections.

At block 508, method 500 comprises receiving by a query tool (e.g., query tool 166 illustrated in FIG. 1) of the ontology engine a query from a user concerning a hypothetical modification to the operation of the data handling facility. At block 510, method 500 comprises forecasting by the ontology engine a change in the operation of one or more of the plurality of electrically powered components of the data handling facility based on the query received by the query tool from the user.

For example, the ontology engine may forecast a shortfall in electrical power supplied to one or more server racks of the data handling facility in response to a particular genset of the data handling facility going offline. In another example, the ontology engine may forecast a shortfall in cooling capacity for a particular room of the data handling facility resulting from the addition of network servers to the room of the data handling facility resulting in overheating of the network servers. In some embodiments, the ontology engine may prompt the user of the forecasted shortfall in capacity (e.g., space, power, cooling, and/or network capacity) resulting from the change in operation, permitting the user to take timely action (via adding the required space, power, cooling, and/or network capacity) to address the forecasted shortfall before undesirable consequences occur. In

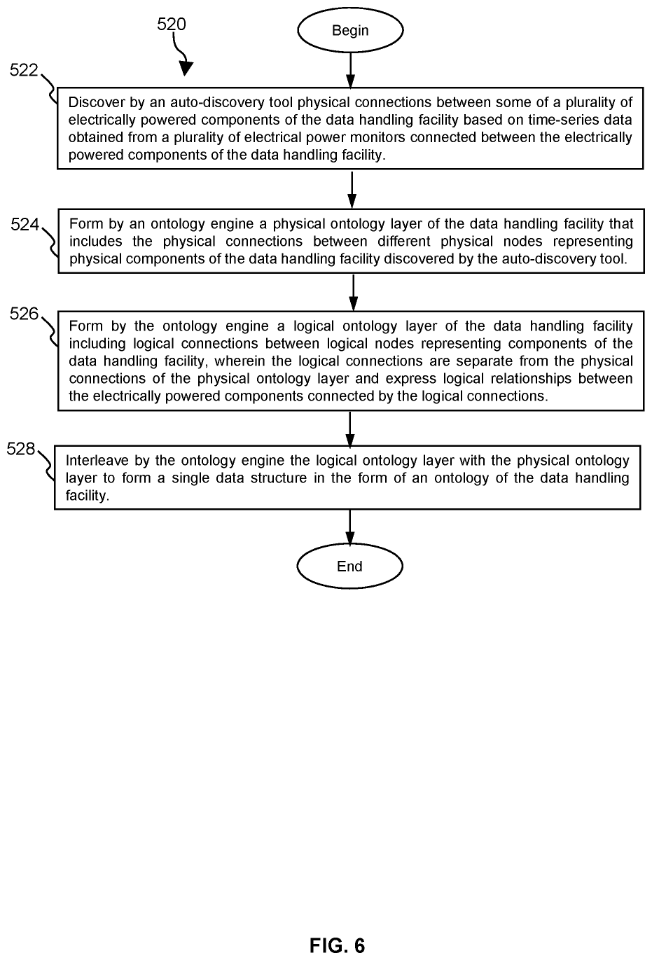

Turning to FIG. 6, a method 520 is described. In an embodiment, the method 520 is a method for managing an ontology (e.g., facility ontology 400 illustrated in FIG. 4) of a data handling facility (e.g., data handling facilities 126 illustrated in FIG. 1 and/or data handling facility 200 illustrated in FIG. 1) of a communication system (e.g., communication system 100 illustrated in FIG. 1). Method 520 may also be said to comprise a method of operating and/or maintaining a data handling facility and/or a communication system. At block 522, method 520 comprises discovering by an auto-discovery tool (e.g., auto-discovery tool 162 illustrated in FIG. 1) physical connections between some of a plurality of electrically powered components (e.g., electrically powered components illustrated in FIGS. 2-4) of the data handling facility based on time-series data (e.g., facility power dataset 144 illustrated in FIG. 1) obtained from a plurality of electrical power monitors (e.g., power monitors 262, 264 illustrated in FIG. 2 and/or power monitors 352 and 354 illustrated in FIG. 3) connected between the electrically powered components of the data handling facility.

At block 524, method 520 comprises forming by an ontology engine (e.g., ontology engine 164 illustrated in FIG. 1) a physical ontology layer of the data handling facility that includes the physical connections (e.g., physical edges illustrated in FIG. 4) between different physical nodes (e.g., physical nodes illustrated in FIG. 4) representing physical components of the data handling facility discovered by the auto-discovery tool. At block 526, method 520 comprises forming by the ontology engine a logical ontology layer of the data handling facility including logical connections (e.g., logical edges 402 illustrated in FIG. 4) between logical nodes (e.g., logical nodes illustrated in FIG. 4) representing components of the data handling facility, wherein the logical connections are separate from the physical connections of the physical ontology layer and express logical relationships between the electrically powered components connected by the logical connections. At block 528, method 520 comprises interleaving by the ontology engine the logical ontology layer with the physical ontology layer to form a single data structure in the form of an ontology of the data handling facility. For example, the physical and logical ontology layers may be interleaved to form a single graphical data structure such as a knowledge graph indicating both physical and logical connections between different electrically powered components of the data handling facility. In this manner, a user viewing the graphical data structure may gain insight into the logical organization of the data handling facility such as how changes in operation to a first electrically powered component could result in undesirable changes in operation to other electrically powered components that are not physically connected (at least not directly) to the first electrically powered component. In other words, the multi-layered graphical data structure may make plain logical connections between various pieces of equipment that would be otherwise inscrutable when viewing a similar graphical data structure limited to only a physical ontology of the facility. In some instances, the ontology engine may prompt or warn the user of forecasted issues resulting from hypothetical changes to the operation of the data handling facility provided to the ontology engine by the user as well as provide recommendations to the user of how to address the potential operational impacts (e.g., via the addition of new power distribution equipment such as electrical switching devices and the like.

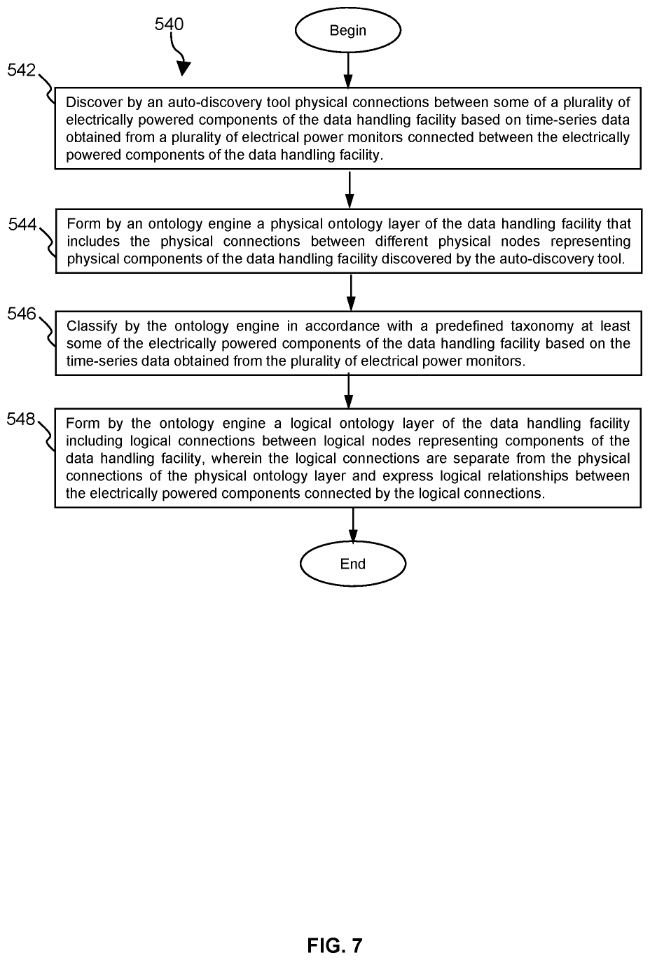

Turning to FIG. 7, a method 540 is described. In an embodiment, the method 540 is a method for managing an ontology (e.g., facility ontology 400 illustrated in FIG. 4) of a data handling facility (e.g., data handling facilities 126 illustrated in FIG. 1 and/or data handling facility 200 illustrated in FIG. 1) of a communication system (e.g., communication system 100 illustrated in FIG. 1. Method 540 may also be said to comprise a method of operating and/or maintaining a data handling facility and/or a communication system. At block 542, method 540 comprises discovering by an auto-discovery tool (e.g., auto-discovery tool 162 illustrated in FIG. 1) physical connections between some of a plurality of electrically powered components (e.g., electrically powered components illustrated in FIGS. 2-4) of the data handling facility based on time-series data (e.g., facility power dataset 144 illustrated in FIG. 1) obtained from a plurality of electrical power monitors (e.g., power monitors 262, 264 illustrated in FIG. 2 and/or power monitors 352 and 354 illustrated in FIG. 3) connected between the electrically powered components of the data handling facility.

At block 544, method 540 comprises forming by an ontology engine (e.g., ontology engine 164 illustrated in FIG. 1) a physical ontology layer of the data handling facility that includes the physical connections (e.g., physical edges illustrated in FIG. 4) between different physical nodes (e.g., physical nodes illustrated in FIG. 4) representing physical components of the data handling facility discovered by the auto-discovery tool. At block 546, method 540 comprises classifying by the ontology engine in accordance with a predefined taxonomy at least some of the electrically powered components of the data handling facility based on the time-series data obtained from the plurality of electrical power monitors. At block 548, method 540 comprises forming by the ontology engine a logical ontology layer of the data handling facility including logical connections (e.g., logical edges 402 illustrated in FIG. 4) between logical nodes (e.g., logical nodes illustrated in FIG. 4) representing components of the data handling facility, wherein the logical connections are separate from the physical connections of the physical ontology layer and express logical relationships between the electrically powered components connected by the logical connections.

The logical connections may provide a user of the ontology engine with additional insight into the underlying logical organization of the data handling facility such that the user may greater appreciate how changes to the operation of a first component of the data handling facility may impact the operation of other components of the data handling facility. Indeed, in some instances, the ontology engine may warn the user of forecasted issues resulting from hypothetical changes to the operation of the data handling facility provided to the ontology engine by the user. For instance, the ontology engine may prompt the user regarding the undesirable operational impacts of the hypothetical loss of electrical power from a given component of the data handling facility as well as provide recommendations to the user of how to address the potential operational impacts (e.g., via the addition of new power distribution equipment such as electrical switching devices and the like.

Turning now to FIG. 8A, an exemplary communication system 650 is described. Typically, the communication system 650 includes a number of access nodes 654 that are configured to provide coverage in which UEs 652 such as cell phones, tablet computers, machine-type-communication devices, tracking devices, embedded wireless modules, and/or other wirelessly equipped communication devices (whether or not user operated), can operate. The access nodes 654 may be said to establish an access network 656. The access network 656 may be referred to as a radio access network (RAN) in some contexts.

In a 5G technology generation an access node 654 may be referred to as a next Generation Node B (gNB). In 4G technology (e.g., long term evolution (LTE) technology) an access node 654 may be referred to as an evolved Node B (eNB). In 3G technology (e.g., code division multiple access (CDMA) and global system for mobile communication (GSM)) an access node 654 may be referred to as a base transceiver station (BTS) combined with a base station controller (BSC). In some contexts, the access node 654 may be referred to as a cell site or a cell tower. In some implementations, a picocell may provide some of the functionality of an access node 654, albeit with a constrained coverage area. Each of these different embodiments of an access node 654 may be considered to provide roughly similar functions in the different technology generations.

In an embodiment, the access network 656 comprises a first access node 654a, a second access node 654b, and a third access node 654c. It is understood that the access network 656 may include any number of access nodes 654. Further, each access node 654 could be coupled with a core network 658 that provides connectivity with various application servers 659 and/or a network 660. In an embodiment, at least some of the application servers 659 may be located close to the network edge (e.g., geographically close to the UE 652 and the end user) to deliver so-called “edge computing.” The network 660 may be one or more private networks, one or more public networks, or a combination thereof. The network 660 may comprise the public switched telephone network (PSTN). The network 660 may comprise the Internet. With this arrangement, a UE 652 within coverage of the access network 656 could engage in air-interface communication with an access node 654 and could thereby communicate via the access node 654 with various application servers and other entities.

The communication system 650 could operate in accordance with a particular radio access technology (RAT), with communications from an access node 654 to UEs 652 defining a downlink or forward link and communications from the UEs 652 to the access node 654 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as Long Term Evolution (LTE), which facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 654 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 654 could define an air interface configured in a specific manner to define physical resources for carrying information wirelessly between the access node 654 and UEs 652.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 652.

In addition, certain resource elements on the example air interface could be reserved for special purposes. For instance, on the downlink, certain resource elements could be reserved to carry synchronization signals that UEs 652 could detect as an indication of the presence of coverage and to establish frame timing, other resource elements could be reserved to carry a reference signal that UEs 652 could measure in order to determine coverage strength, and still other resource elements could be reserved to carry other control signaling such as PRB-scheduling directives and acknowledgement messaging from the access node 654 to served UEs 652. And on the uplink, certain resource elements could be reserved to carry random access signaling from UEs 652 to the access node 654, and other resource elements could be reserved to carry other control signaling such as PRB-scheduling requests and acknowledgement signaling from UEs 652 to the access node 654.

The access node 654, in some instances, may be split functionally into a radio unit (RU), a distributed unit (DU), and a central unit (CU) where each of the RU, DU, and CU have distinctive roles to play in the access network 656. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 8B, further details of the core network 658 are described. In an embodiment, the core network 658 is a 5G core network. 5G core network technology is based on a service based architecture paradigm. Rather than constructing the 5G core network as a series of special purpose communication nodes (e.g., an HSS node, a MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 679, an authentication server function (AUSF) 675, an access and mobility management function (AMF) 676, a SMF 677, a network exposure function (NEF) 670, a network repository function (NRF) 671, a policy control function (PCF) 672, a UDM 673, a network slice selection function (NSSF) 674, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 658 may be segregated into a user plane 680 and a control plane 682, thereby promoting independent scalability, evolution, and flexible deployment.

The UPF 679 delivers packet processing and links the UE 652, via the access network 656, to a data network 690 (e.g., the network 660 illustrated in FIG. 8A). The AMF 676 handles registration and connection management of non-access stratum (NAS) signaling with the UE 652. Said in other words, the AMF 676 manages UE registration and mobility issues. The AMF 676 manages reachability of the UEs 652 as well as various security issues. The SMF 677 handles session management issues. Specifically, the SMF 677 creates, updates, and removes (destroys) PDU sessions and manages the session context within the UPF 679. The SMF 677 decouples other control plane functions from user plane functions by performing dynamic host configuration protocol (DHCP) functions and IP address management functions. The AUSF 675 facilitates security processes.

The NEF 670 securely exposes the services and capabilities provided by network functions. The NRF 671 supports service registration by network functions and discovery of network functions by other network functions. The PCF 672 supports policy control decisions and flow based charging control. The UDM 673 manages network user data and can be paired with a user data repository (UDR) that stores user data such as customer profile information, customer authentication number, and encryption keys for the information. An application function 692, which may be located outside of the core network 658, exposes the application layer for interacting with the core network 658. In an embodiment, the application function 692 may be execute on an application server 659 located geographically proximate to the UE 652 in an “edge computing” deployment mode. The core network 658 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 674 can help the AMF 676 to select the network slice instance (NSI) for use with the UE 652.

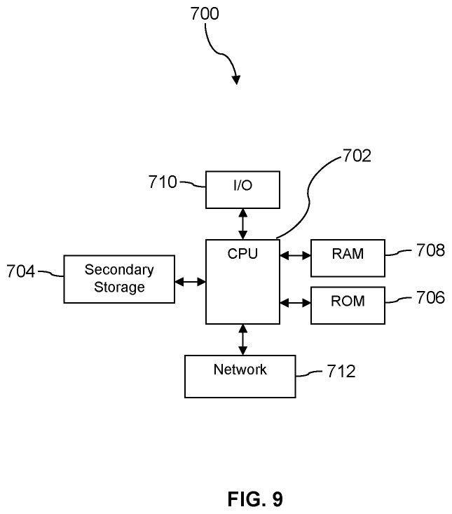

FIG. 9 illustrates a computer system 700 suitable for implementing one or more embodiments disclosed herein. The computer system 700 includes a processor 702 (which may be referred to as a central processor unit or CPU) that is in communication with memory devices including secondary storage 704, read only memory (ROM) 706, random access memory (RAM) 708, input/output (I/O) devices 710, and network connectivity devices 712. The processor 702 may be implemented as one or more CPU chips.

It is understood that by programming and/or loading executable instructions onto the computer system 700, at least one of the CPU 702, the RAM 708, and the ROM 706 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 700 is turned on or booted, the CPU 702 may execute a computer program or application. For example, the CPU 702 may execute software or firmware stored in the ROM 706 or stored in the RAM 708. In some cases, on boot and/or when the application is initiated, the CPU 702 may copy the application or portions of the application from the secondary storage 704 to the RAM 708 or to memory space within the CPU 702 itself, and the CPU 702 may then execute instructions that the application is comprised of. In some cases, the CPU 702 may copy the application or portions of the application from memory accessed via the network connectivity devices 712 or via the I/O devices 710 to the RAM 708 or to memory space within the CPU 702, and the CPU 702 may then execute instructions that the application is comprised of. During execution, an application may load instructions into the CPU 702, for example load some of the instructions of the application into a cache of the CPU 702. In some contexts, an application that is executed may be said to configure the CPU 702 to do something, e.g., to configure the CPU 702 to perform the function or functions promoted by the subject application. When the CPU 702 is configured in this way by the application, the CPU 702 becomes a specific purpose computer or a specific purpose machine.

The secondary storage 704 is typically comprised of one or more disk drives or tape drives and is used for non-volatile storage of data and as an over-flow data storage device if RAM 708 is not large enough to hold all working data. Secondary storage 704 may be used to store programs which are loaded into RAM 708 when such programs are selected for execution. The ROM 706 is used to store instructions and perhaps data which are read during program execution. ROM 706 is a non-volatile memory device which typically has a small memory capacity relative to the larger memory capacity of secondary storage 704. The RAM 708 is used to store volatile data and perhaps to store instructions. Access to both ROM 706 and RAM 708 is typically faster than to secondary storage 704. The secondary storage 704, the RAM 708, and/or the ROM 706 may be referred to in some contexts as computer readable storage media and/or non-transitory computer readable media.

I/O devices 710 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 712 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 712 may provide wired communication links and/or wireless communication links (e.g., a first network connectivity device 712 may provide a wired communication link and a second network connectivity device 712 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 712 may enable the processor 702 to communicate with the Internet or one or more intranets. With such a network connection, it is contemplated that the processor 702 might receive information from the network, or might output information to the network in the course of performing the above-described method steps. Such information, which is often represented as a sequence of instructions to be executed using processor 702, may be received from and outputted to the network, for example, in the form of a computer data signal embodied in a carrier wave.

Such information, which may include data or instructions to be executed using processor 702 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 702 executes instructions, codes, computer programs, scripts which it accesses from hard disk, floppy disk, optical disk (these various disk-based systems may all be considered secondary storage 704), flash drive, ROM 706, RAM 708, or the network connectivity devices 712. While only one processor 702 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 704, for example, hard drives, floppy disks, optical disks, and/or other device, the ROM 706, and/or the RAM 708 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a dataset by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 704, to the ROM 706, to the RAM 708, and/or to other non-volatile memory and volatile memory of the computer system 700. The processor 702 may process the executable instructions and/or data structures in part by directly accessing the computer program product, for example by reading from a CD-ROM disk inserted into a disk drive peripheral of the computer system 700. Alternatively, the processor 702 may process the executable instructions and/or data structures by remotely accessing the computer program product, for example by downloading the executable instructions and/or data structures from a remote server through the network connectivity devices 712. The computer program product may comprise instructions that promote the loading and/or copying of data, data structures, files, and/or executable instructions to the secondary storage 704, to the ROM 706, to the RAM 708, and/or to other non-volatile memory and volatile memory of the computer system 700.

In some contexts, the secondary storage 704, the ROM 706, and the RAM 708 may be referred to as a non-transitory computer readable medium or a computer readable storage media. A dynamic RAM embodiment of the RAM 708, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 702 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for managing an ontology of a data handling facility of a communication system, the method comprising:
discovering by an auto-discovery tool physical connections between some of a plurality of electrically powered components of the data handling facility based on time-series data obtained from a plurality of electrical power monitors connected between the electrically powered components of the data handling facility;
forming by an ontology engine a physical ontology layer of the data handling facility that includes the physical connections between different physical nodes representing physical components of the data handling facility discovered by the auto-discovery tool;
forming by the ontology engine a logical ontology layer of the data handling facility including logical connections between logical nodes representing components of the data handling facility, wherein the logical connections are separate from the physical connections of the physical ontology layer and express logical relationships between the electrically powered components connected by the logical connections;
receiving by a query tool of the ontology engine a query from a user concerning a hypothetical modification to the operation of the data handling facility; and
forecasting by the ontology engine a change in the operation of one or more of the plurality of electrically powered components of the data handling facility based on the query received by the query tool from the user.

2. The method of claim 1, wherein the forecasted change in the operation of the one or more of the plurality of electrically powered components comprises a forecasted change in a flow of electrical power between the one or more of the plurality of electrically powered components.

3. The method of claim 1, further comprising:
forecasting by the ontology engine an anticipated shortfall in electrical power capacity for the data handling facility based on the query received by the query tool from the user; and
adding electrical power distribution components to the data handling facility to avoid the forecasted shortfall in electrical power capacity.

4. The method of claim 1, further comprising:
forecasting by the ontology engine an anticipated shortfall in network capacity for the communication system based on the query received by the query tool from the user; and
recommending by the ontology engine adding network switching or network routing components to the data handling facility to avoid the forecasted shortfall of network capacity.

5. The method of claim 1, further comprising:
forecasting by the ontology engine a change in a flow of network traffic across the communication system based on the query received by the query tool from the user.

6. The method of claim 1, wherein at least some of the logical edges comprise system edges indicating that the logical nodes connected by the system edge belong to a common system of the data handling facility.

7. The method of claim 1, wherein at least some of the physical edges comprise structural edges connecting nodes representing infrastructural components of the data handling facility.

8. The method of claim 1, wherein at least some of the physical components of represented by the physical nodes of the physical ontology layer comprise electrically powered components and infrastructural components of the data handling facility.

9. A method for managing an ontology of a data handling facility of a communication system, the method comprising:
discovering by an auto-discovery tool physical connections between some of a plurality of electrically powered components of the data handling facility based on time-series data obtained from a plurality of electrical power monitors connected between the electrically powered components of the data handling facility;
forming by an ontology engine a physical ontology layer of the data handling facility that includes the physical connections between different physical nodes representing physical components of the data handling facility discovered by the auto-discovery tool;
forming by the ontology engine a logical ontology layer of the data handling facility including logical connections between logical nodes representing components of the data handling facility, wherein the logical connections are separate from the physical connections of the physical ontology layer and express logical relationships between the electrically powered components connected by the logical connections; and
interleaving by the ontology engine the logical ontology layer with the physical ontology layer to form a single data structure in the form of an ontology of the data handling facility.

10. The method of claim 9, wherein the single data structure is a graphical data structure in the form of a knowledge graph comprising physical edges corresponding to the physical ontology layer and logical edges corresponding to the logical ontology layer.

11. The method of claim 10, wherein at least some of the logical edges comprise system edges indicating that the logical nodes connected by the system edge belong to a common system of the data handling facility.

12. The method of claim 9, wherein at least some of the physical edges comprise structural edges connecting nodes representing infrastructural components of the data handling facility.

13. The method of claim 9, wherein the single data structure comprises a database data structure with the logical nodes and the physical nodes each comprising entries in the database data structure.

14. The method of claim 9, wherein at least some of the physical components of represented by the physical nodes of the physical ontology layer comprise electrically powered components and infrastructural components of the data handling facility.

15. The method of claim 9, wherein at least some of the components represented by the logical nodes comprise systems and at least some of the physical components of the data handling facility.

16. A method for managing an ontology of a data handling facility of a communication system, the method comprising:
discovering by an auto-discovery tool physical connections between some of a plurality of electrically powered components of the data handling facility based on time-series data obtained from a plurality of electrical power monitors connected between the electrically powered components of the data handling facility;
forming by an ontology engine a physical ontology layer of the data handling facility that includes the physical connections between different physical nodes representing physical components of the data handling facility discovered by the auto-discovery tool;
classifying by the ontology engine in accordance with a predefined taxonomy at least some of the electrically powered components of the data handling facility based on the time-series data obtained from the plurality of electrical power monitors; and
forming by the ontology engine a logical ontology layer of the data handling facility including logical connections between logical nodes representing components of the data handling facility, wherein the logical connections are separate from the physical connections of the physical ontology layer and express logical relationships between the electrically powered components connected by the logical connections.

17. The method of claim 16, wherein the predefined taxonomy comprises a plurality of predefined and separate component classes.

18. The method of claim 16, wherein the predefined taxonomy comprises a plurality of predefined and separate component classes including electrical transformers, electrical switching devices, and electrical rectifiers.

19. The method of claim 16, wherein at least some of the logical edges comprise system edges indicating that the logical nodes connected by the system edge belong to a common system of the data handling facility.

20. The method of claim 16, wherein at least some of the physical edges comprise structural edges connecting nodes representing infrastructural components of the data handling facility.
